(19) United States
(12) Patent Application Publication
(10) Pub. No.: US 2024/0049059 A1
(43) Pub. Date: Feb. 8, 2024

(54) PER STATION MULTI-LINK TIME SCHEDULING

(71) Applicant: Cisco Technology, Inc., San Jose, CA (US)

(72) Inventors: Malcolm Muir Smith, Richardson, TX (US); Jerome Henry, Pittsboro, NC (US); Robert E. Barton, Richmond (CA); Indermeet Singh Gandhi, San Jose, CA (US)

(73) Assignee: Cisco Technology, Inc., San Jose, CA (US)

(21) Appl. No.: 17/817,531

(22) Filed: Aug. 4, 2022

(51) Int. Cl. H04W 28/24; H04W 28/02

(52) U.S. Cl. CPC H04W 28/24; H04W 28/0236; H04W 28/0268

(57) ABSTRACT

Per station multi-link time scheduling may be provided. An Access Point (AP) may receive a request from a Multi-Link Device (MLD) to send a plurality of data traffics in a network for a predetermined interval. A Quality of Service (QoS) requirement may be determined for each of the plurality of data traffics. A Traffic Identifier (TID)-to-link assignment may be determined for each of the plurality of data traffics. Determining the TID-to-link assignment may comprise determining a link state of each of a plurality of links envisioned for the MLD for the predetermined interval. Each of the plurality of data traffics may be assigned to one or more of the plurality of links based on the QoS requirement for each of the plurality of data traffics and the link state of each of the plurality of links envisioned for the MLD. The TID-to-link assignment may be sent to the MLD.

### TECHNICAL FIELD

The present disclosure relates generally to scheduling of wireless networks.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for per station multi-link time scheduling;

FIG. 2 is a flow chart of a method for providing per station multi-link time scheduling; abd

FIG. 3 is a block diagram of a computing device.

### DETAILED DESCRIPTION

### Overview

Per station multi-link time scheduling may be provided. An Access Point (AP) may receive a request from a Multi-Link Device (MLD) to send a plurality of data traffics in a network for a predetermined interval. A Quality of Service (QoS) requirement may be determined for each of the plurality of data traffics. A Traffic Identifier (TID)-to-link assignment may be determined for each of the plurality of data traffics. Determining the TID-to-link assignment may comprise determining a link state of each of a plurality of links envisioned for the MLD for the predetermined interval. Each of the plurality of data traffics may be assigned to one or more of the plurality of links based on the QoS requirement for each of the plurality of data traffics and the link state of each of the plurality of links envisioned for the MLD. The TID-to-link assignment may be sent to the MLD.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

With the emergence of dual-radio client devices and tri-band Access Points (APs) capable of simultaneously operating at 2.4 GHz, 5 GHz, and 6 GHz Radio Frequency (RF) bands, one of the objectives of the Institute of Electrical and Electronics Engineers (IEEE) 802.11be may be to make more efficient use of multiple bands and the channels therein. IEEE 802.11be may disclose Wi-Fi standards that may further enhance capabilities of wireless devices (e.g., IEEE 802.11ax devices) currently on the market. For example, a Multi-Link Device (MLD) may include multiple radios and antennas that may provide a capability of simultaneous operation on multiple channels. To take advantage of the multi-radio devices, 802.11be may provide multi-link operation (MLO) that may provide a framework to enable packet-level aggregation at the Media Access Control (MAC) layer so that frames from a single traffic session, such as video frames for example, may be sent on multiple links. IEEE 802.11 may use the term “link” to refer to a unique wireless channel.

The IEEE 802.11ax may introduce Orthogonal Frequency-Division Multiple Access (OFDMA) as an uplink transmission mode to allow scheduled access-based transmissions. This may allow an AP to dynamically schedule uplink OFDMA based on a client device's uplink traffic type and queue depth. MLO may allow a MLD to establish multiple links to an AP. However, MLO may not yet provide a MLD with a capability to interact with the AP in a manner compatible with Advanced Service Request (ASR). Accordingly, embodiments of the disclosure may provide processes to schedule a multi-link setup for a MLD based on ASR and QoS requirements.

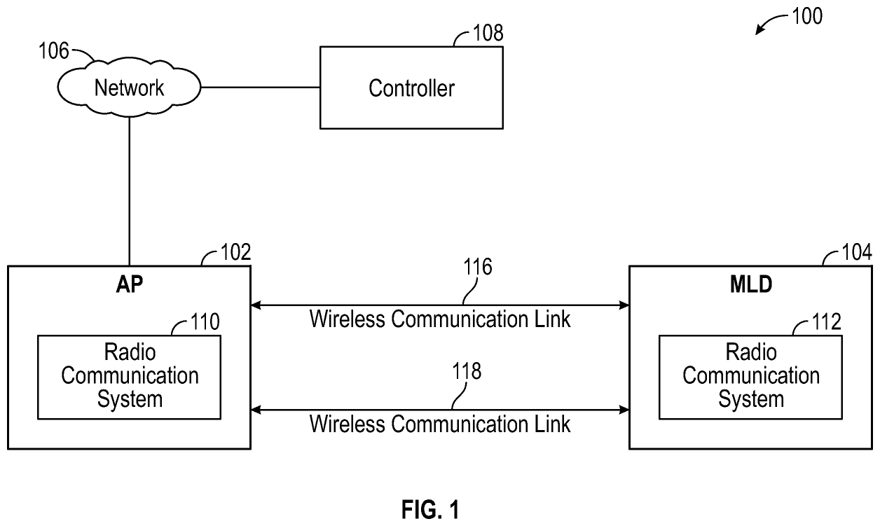

FIG. 1 shows an operating environment 100 for per station multi-link time scheduling. As shown in FIG. 1, operating environment 100 may include an AP 102, a MLD 104, a network 106, and a controller 108. Operating environment 100 is not so limited and may include multiple APs and multiple MLDs. MLD 104 may be associated with one or more APs, including AP 102. An example AP 102 may include a first integrated radio communication system 110 that may include a plurality of radios and antennas. Likewise, MLD 104 may include a second integrated radio communication system 112 that may include a plurality of radios and antennas. First radio communication system 110 and second radio communication system 112 may be operable to communicate on multiple Wireless Communication Links (WCLs) or channels. AP 102 and MLD 104 may respectively use first integrated radio communication systems 110 and second radio communication system 112 to establish communication over wireless network 106 (e.g., a Wireless Local Area Network (WLAN)).

As shown in FIG. 1, a first WCL 116 and a second WCL 118 have been established between AP 102 and MLD 104 according to the IEEE 802.11 wireless protocol for example. However, MLD 104 may establish first WCL 116 and second WCL 118 with different APs, including AP 102. In some cases, depending on the capabilities of AP 102 and MLD 104, it may be possible to utilize multiple spatial streams (e.g., 4, 8, 16, etc.) to communicate within operating environment 100.

AP 102 may be a networking hardware device that enables other devices, such as MLD 104, to connect to network 106. As an example, AP 102 may be configured with a multi-radio software controller for use with Long Term Evolution (LTE), Wireless Fidelity (Wi-Fi), Worldwide Interoperability for Microwave Access (WiMAX), Global System for Mobile (GSM) Communications, Code Division Multiple Access (CDMA), Wideband Code Division Multiple Access (WCDMA), etc. that may include N (e.g., 2, 4, 8, 16, etc.) independent 2×2 transceivers, N independent two channel receivers or sniffers, a radio frequency band from about 70 Megahertz (MHz) to about 6 Gigahertz (GHz) for example, and a tunable channel bandwidth.

MLD 104 may comprise, but is not limited to, an AP, a phone, a smartphone, a digital camera, a tablet device, a laptop computer, a personal computer, a mobile device, a sensor, an Internet-of-Things (IoTs) device, a cellular base station, a telephone, a remote control device, a set-top box, a digital video recorder, a cable modem, a network computer, a mainframe, a router, or any other similar microcomputer-based device capable of accessing and using a Wi-Fi network.

Controller 108 may comprise a Wireless Local Area Network controller (WLC) and may provision and control operating environment 100 (e.g., the WLAN). Controller 108 may allow the plurality of client devices to join operating environment 100. In some embodiments of the disclosure, controller 108 may be implemented by a Digital Network Architecture Center (DNAC) controller (i.e., a Software-Defined Network (SDN) controller).

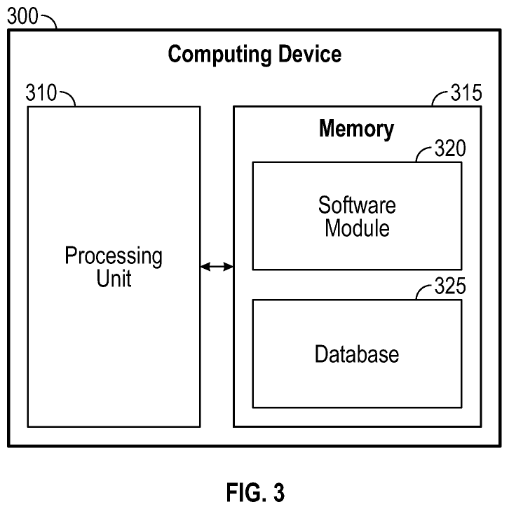

The elements described above of operating environment 100 (e.g., AP 102, MLD 104, and controller 108) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 3, the elements of operating environment 100 may be practiced in a computing device 300.

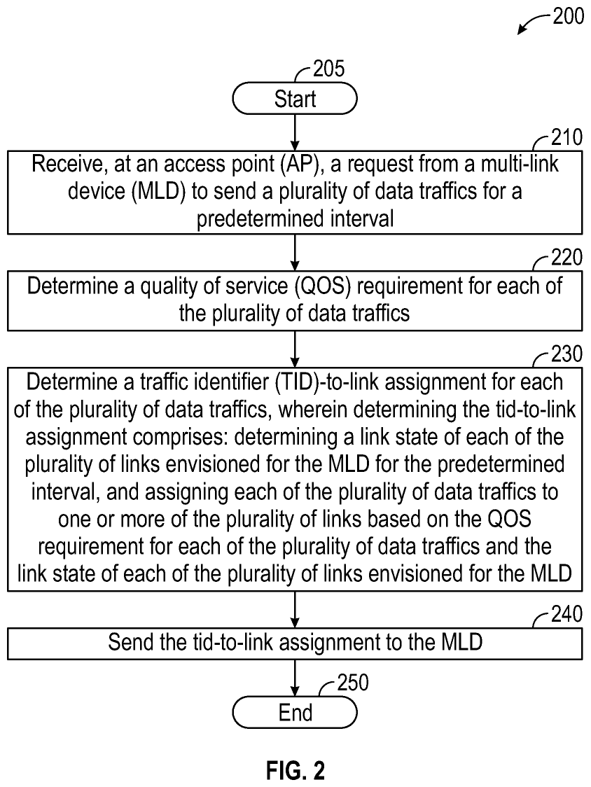

FIG. 2 is a flow chart setting forth the general stages involved in a method 200 consistent with an embodiment of the disclosure for providing per station multi-link time scheduling. Method 200 may be implemented using AP 102 as described in more detail above with respect to FIG. 1. Ways to implement the stages of method 200 will be described in greater detail below.

Method 200 may begin at starting block 205 and proceed to stage 210 where AP 102 may receive a request from MLD 104 to send a plurality of data traffics in network 106 for a predetermined interval. For example, MLD 104 may transmit an ASR to AP 102 indicating a planned uplink traffic fora predetermined interval (e.g., 10-15 seconds). The predetermined interval may also be referred to as a service period. The uplink traffic may originate from an application (e.g., a video conferencing application) on MLD 104. The uplink traffic may include a plurality of data traffics or flows, for example, a voice data traffic, a video data traffic, a background data traffic, a telemetry data traffic, etc. In the ASR, MLD 104 may include a TID and a QoS requirement for each of the plurality of data traffics. In addition, in the ASR, MLD 104 may indicate that it may support multiple links or that it is a multi-link capable device. AP 102 may receive the request from MLD 104 to send a plurality of data traffics on an already associated link, for example, first WCL 116.

From stage 210, where AP 102 receives the request from MLD 104 to send the plurality of data traffics in network 106 for the predetermined interval, method 200 may advance to stage 220 where AP 102 may determine the QoS requirement for each of the plurality of data traffics. For example, AP 102 may determine the QoS requirement for each of the plurality of data traffics from the ASR request received from MLD 104. The QoS requirement may comprises, for example, a bit rate, periodicity, latency sensitivity, a delay level, a packet loss level, etc.

Once AP 102 determines the QoS requirement for each of the plurality of data traffics in stage 220, method 200 may continue to stage 230 where AP 102 may determine a TID-to-link assignment for each of the plurality of data traffics. Determining the TID-to-link assignment may comprise: i) determining a link state for each of a plurality of links envisioned for MLD 104 for the predetermined interval; and ii) assigning each of the plurality of data traffics to one or more of the plurality of links based on the QoS requirement of each of the plurality of data traffics and the link state of each of the plurality of links envisioned for MLD 104. For example, AP 102 may determine a current state of each of a plurality of links envisioned for MLD 104 (e.g., first WCL 116 and second WCL 118). The current state may include, for example, a bandwidth level, a delay level, a packet loss level, a data latency level, etc. AP 102 may then assign each of the plurality of data traffics to one or more of the plurality of links based on the QoS requirement for each of the plurality of data traffics and the link state for each of the plurality of links envisioned for MLD 104. AP 102 may create a TID-to-link mapping or TID-to-link suggestion based on the assignment. AP 102 may establish the TID-to-link-assignment for each planned Uplink (UL) trigger time based on the service period of each the one or more of the plurality of links and associated TIDs (e.g., every 20 ms for the next 5 s of a voice data traffic including TID6/7).

After AP 102 determines the TID-to-link assignment for each of the plurality of data traffics in stage 230, method 200 may proceed to stage 240 where AP 102 may send the TID-to-link assignment to MLD 104. The TID-to-link map may be sent to MLD 104 via either a Wi-Fi7 TID-to-link assignment action frame or a TID-to-link mapping action frame. The plurality of data traffics may be transported over the suggested or updated links. If the TID-to-link assignment is successfully delivered to MLD 104, a corresponding periodic UL schedule for each of the plurality of data traffics may be configured in a link scheduler. Once AP 102 sends the TID-to-link assignment to MLD 104 in stage 240, method 200 may then end at stage 250.

In example embodiments, MLD 104 may use Wi-Fi 7 a restricted Target Wake Time (rTWT) signal to send the service period for a critical traffic with a traffic periodicity and traffic characteristics. AP 102 then may use the rTWT signal to assign the service period to MLD 104 on one or more the plurality of links envisioned for MLD 104 as discussed above with reference to FIG. 2.

AP 102 may re-evaluate the TID-to-link assignment established above (e.g. after a predetermined sub-interval (e.g., 5 s) and revert back to a previous or an alternate TID-to-link assignment. AP 102 may, for example, re-evaluate the TID-to-link assignment after receiving an updated or a new request from MLD 104 indicating that a portion or all of the plurality of data traffics has stopped or that the initial request is no longer relevant. In addition, AP 102 may re-evaluate the TID-to-link assignment when the link state of a portion of the plurality of links have changed. Moreover, AP 102 may steer a data traffic away from a link that is deteriorated or for power-saving, and may re-evaluate the TID-to-link assignment.

In some embodiments of the disclosure, AP 102 may consider a new link supported and associated with MLD 104 but currently not assigned any TID from the request. If the new link would yield a better outcome for MLD 104 (e.g. latency), AP 102 may initiate reconfiguration of the TID-to-link assignment. AP 102, for example, may add the new link to a list of plurality of links envisioned for MLD 104 and then re-evaluate and reconfigure the TID-to-link assignment. The TID-to-link assignment reconfiguration information may be communicated to MLD 104 using the TID-to-link mapping action frame. Similarly, a link may be removed from the list of the plurality of links envisioned for MLD 104 if the link fails to meet the QOS requirement.

FIG. 3 shows computing device 300. As shown in FIG. 3, computing device 300 may include a processing unit 310 and a memory unit 315. Memory unit 315 may include a software module 320 and a database 325. While executing on processing unit 310, software module 320 may perform, for example, processes for providing per station multi-link time scheduling as described above with respect to FIG. 2. Computing device 300, for example, may provide an operating environment for AP 102, MLD 104, and controller 108. AP 102, MLD 104, and controller 108 may operate in other environments and are not limited to computing device 300.

Computing device 300 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 300 may comprise any computer operating environment, such as hand-held devices, multiprocessor systems, microprocessor-based or programmable sender electronic devices, minicomputers, mainframe computers, and the like. Computing device 300 may also be practiced in distributed computing environments where tasks are performed by remote processing devices. The aforementioned systems and devices are examples, and computing device 300 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 300 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving, at an Access Point (AP), a request from a Multi-Link Device (MLD) to send a plurality of data traffics in a network for a predetermined interval;
determining a Quality of Service (QoS) requirement for each of the plurality of data traffics;
determining a Traffic Identifier (TID)-to-link assignment for each of the plurality of data traffics, wherein determining the TID-to-link assignment comprises:
determining a link state of each of a plurality of links envisioned for the MLD for the predetermined interval, and
assigning each of the plurality of data traffics to one or more of the plurality of links based on the QoS requirement for each of the plurality of data traffics and the link state of each of the plurality of links envisioned for the MLD; and
sending the TID-to-link assignment to the MLD.

2. The method of claim 1, further comprising scheduling an Uplink (UL) trigger time based on the predetermined interval for each of the plurality of data traffics and one or more of the plurality of links.

3. The method of claim 1, wherein sending the TID-to-link assignment to the MLD comprises sending the TID-to-link assignment to the MLD in a TID-to-link assignment action frame.

4. The method of claim 1, wherein receiving the request from the MLD comprises receiving the request from the MLD in a restricted Target Wake Time (rTWT) signal.

5. The method of claim 1, further comprising re-evaluating the TID-to-link assignment in a predetermined sub-interval of the predetermined interval.

6. The method of claim 1, further comprising re-evaluating the TID-to-link assignment in response to one of the following:
receiving a new request from the MLD;
detecting a change in the link state of any of the plurality of links envisioned for the MLD;
detecting deterioration of any of the one or more of the plurality of links; and
detecting a new link for the MLD not listed in the plurality of links envisioned for the MLD.

7. The method of claim 1, further comprising reconfiguring the TID-to-link assignment in response to one of the following:
detecting a change in the link state of any of the plurality of links envisioned for the MLD;
detecting deterioration of any of the one or more of the plurality of links; and
detecting a new link for the MLD not listed in the plurality of links envisioned for the MLD.

8. A system comprising:
a memory storage; and
a processing unit coupled to the memory storage, wherein the processing unit is operative to:
receive a request from a Multi-Link Device (MLD) to send a plurality of data traffics in a network for a predetermined interval;
determine a Quality of Service (QoS) requirement for each of the plurality of data traffics;
determine a Traffic Identifier (TID)-to-link assignment for each of the plurality of data traffics, wherein the processing unit being operative to determine the TID-to-link assignment comprises the processing unit being operative to:
determine a link state for each of a plurality of links envisioned for the MLD for the predetermined interval, and
assign each of the plurality of data traffics to one or more of the plurality of links based on the QoS requirement for each of the plurality of data traffics and the link state of each of the plurality of links envisioned for the MLD; and
send the TID-to-link assignment to the MLD.

9. The system of claim 8, wherein the TID-to-link assignment is sent to the MLD in a TID-to-link assignment action frame.

10. The system of claim 8, wherein the request from the MLD is received in a restricted Target Wake Time (rTWT) signal.

11. The system of claim 8, wherein the processing unit is further operative to re-evaluate the TID-to-link assignment in a predetermined sub-interval of the predetermined interval.

12. The system of claim 8, wherein the processing unit is further operative to reconfigure the TID-to-link assignment in response to one of the following:
detecting a change in the link state of any of the plurality of links envisioned for the MLD;
detecting deterioration of any of the one or more of the plurality of links; and
detecting a new link for the MLD not listed in the plurality of links envisioned for the MLD.

13. The system of claim 8, wherein the processing unit is further operative to re-evaluate the TID-to-link assignment in response to one of the following:
receiving a new request from the MLD;
detecting a change in the link state of any of the plurality of links envisioned for the MLD;
detecting deterioration of any of the one or more of the plurality of links; and
detecting a new link for the MLD not listed in the plurality of links envisioned for the MLD.

14. A computer-readable medium that stores a set of instructions which when executed perform a method executed by the set of instructions comprising:
receiving, at an Access Point (AP), a request from a Multi-Link Device (MLD) to send a plurality of data traffics in a network for a predetermined interval;
determining a Quality of Service (QoS) requirement for each of the plurality of data traffics;
determining a Traffic Identifier (TID)-to-link assignment for each of the plurality of data traffics, wherein determining the TID-to-link assignment comprises:
determining a link state for each of a plurality of links envisioned for the MLD for the predetermined interval, and
assigning each of the plurality of data traffics to one or more of the plurality of links based on the QoS requirement for each of the plurality of data traffics and the link state of each of the plurality of links envisioned for the MLD; and
sending the TID-to-link assignment to the MLD.

15. The computer-readable medium of claim 14, wherein receiving the request from the MLD comprises receiving the request from the MLD in a restricted Target Wake Time (rTWT) signal.

16. The computer-readable medium of claim 14, further comprising scheduling an uplink (UL) trigger time based on the predetermined interval for each of the one or more of the plurality of links.

17. The computer-readable medium of claim 14, wherein sending the TID-to-link assignment to the MLD comprises sending the TID-to-link assignment to the MLD in a TID-to-link assignment action frame.

18. The computer-readable medium of claim 14, further comprising reconfiguring the TID-to-link assignment in response to one of the following:
detecting a change in the link state of any of the plurality of links envisioned for the MLD;
detecting deterioration of any of the one or more of the plurality of links; and
detecting a new link for the MLD not listed in the plurality of links envisioned for the MLD.

19. The computer-readable medium of claim 14, further comprising reevaluating the TID-to-link assignment in a predetermined sub-interval of the predetermined interval.

20. The computer-readable medium of claim 14, further comprising reevaluating the TID-to-link assignment in response to one of the following:
receiving a new request from the MLD;
detecting a change in the link state of any of the plurality of links envisioned for the MLD;
detecting deterioration of any of the one or more of the plurality of links; and
detecting a new link for the MLD not listed in the plurality of links envisioned for the MLD.
